(19) United States
(12) Patent Application Publication
(10) Pub. No.: US 2016/0241650 A1
(43) Pub. Date: Aug. 18, 2016

(54) METHOD, APPARATUS AND SYSTEM FOR REQUESTING ASSOCIATION

(71) Applicant: Huawei Technologies Co., Ltd., Shenzhen (CN)

(72) Inventors: Mu ZHAO, Shenzhen (CN); Xun YANG, Shenzhen (CN)

(21) Appl. No.: 15/137,908

(22) Filed: Apr. 25, 2016

Related U.S. Application Data
(63) Continuation of application No. PCT/CN2013/086346, filed on Oct. 31, 2013.

(51) Int. Cl. H04L 29/08

(52) U.S. Cl. CPC H04L 67/16

(57) ABSTRACT

A method, apparatus and system for requesting association are provided, wherein the method for requesting association includes: an access point receives service demand information carrying with a service identification, and the service identification is identification information of the service required by a service required station; the access point selects a target service station which can provide the service corresponding to the service identification; and the access point associates with the target service station.

### CROSS-REFERENCE TO RELATED APPLICATIONS

This application is a continuation of International Patent Application No. PCT/CN2013/086346, filed on Oct. 31, 2013, which is incorporated herein by reference in its entirety.

### FIELD

Embodiments of the present invention relates to the wireless communication technology, and in particular to a method for requesting an association, an apparatus and a system.

### BACKGROUND

A basic service set (BSS) includes an access point (AP) and at least one station (STA). In a case where the station includes a functional service station such as a projector or a printer and the service station has established an association authentication relationship with the access point, services can be provided to other stations via the access point.

If a station requires a certain service, the access point may select, from service stations which have been associated with the access point, a service station capable of providing the service for the station. Since the access point can select a service station for the station to be served from only the service stations which have been associated with the access point, the service stations need to maintain the association authentication relationship with the access point, so as to ensure that the station can be served in a timely manner.

Network resource is occupied for the service station to maintain the association authentication relationship with the access point, and the service station is not always in an operation state for providing services to other stations. A utilization rate of the network resource is reduced when the service station occupies the network resource to maintain the association authentication relationship with the access point and is in an idle state for waiting to provide service to other stations.

### SUMMARY

In a first aspect of the present invention, a method for requesting an association is provided, which includes:
receiving, by an access point, service requirement information, where the service requirement information carries a service identifier and the service identifier is identification information of a service required by a station to be served;
selecting, by the access point, a target service station capable of providing a service corresponding to the service identifier; and
associating, by the access point, the access point with the target service station.

In conjunction with the method for requesting the association in the first aspect, in a first possible implementation, associating, by the access point, the access point with the target service station includes:
transmitting, by the access point, service request information to the target service station, where the service request information carries the service identifier and the service request information is configured to be used by the target service station to determine whether the target service station has a capability to provide the service corresponding to the service identifier;
receiving, by the access point, service request success information transmitted by the target service station, where the service request success information is generated by the target service station after the target service station determines, based on the service request information, that the target service station has the capability to provide the service corresponding to the service identifier; and
transmitting, by the access point, association request information to the target service station based on the service request success information, where the association request information is configured to be used by the target service station to associate the target service station with the access point.

In conjunction with the method for requesting the association in the first aspect, in a second possible implementation, associating, by the access point, the access point with the target service station includes:
transmitting, by the access point, association request information carrying the service identifier to the target service station, where the association request information is configured to be used by the target service station to associate the target service station with the access point after the target service station determines that the target service station has a capability to provide the service corresponding to the service identifier.

In conjunction with the method for requesting the association in the first aspect, in a third possible implementation, associating, by the access point, the access point with the target service station includes:
transmitting, by the access point, service request information to the target service station, where the service request information carries the service identifier and the service request information is configured to be used by the target service station to determine whether the target service station has a capability to provide the service corresponding to the service identifier; and
associating, by the access point, the access point with the target service station in a case where association request information transmitted by the target service station is received by the access point within a preset period of time, where the association request information is transmitted to the access point by the target service station after the target service station determines, based on the service request information, that the target service station has the capability to provide the service corresponding to the service identifier.

In conjunction with the third possible implementation of the first aspect, in a fourth possible implementation, the method further includes:
retransmitting, by the access point, the service request information to the target service station, in a case where the association request information transmitted by the target service station is not received by the access point within the preset period of time.

In conjunction with the first aspect or the first to fourth possible implementations, in a fifth possible implementation, selecting, by the access point, the target service station capable of providing the service corresponding to the service identifier includes:
selecting, by the access point, a service station which is capable of providing the service corresponding to service identifier and is in an effective period of time for operation, as the target service station.

In a second aspect of the present invention, a method for requesting an association is provided, which includes:
receiving, by a service station, service request information transmitted by an access point, where the service request information carries a service identifier and the service request information is configured to be used by the service station to determine whether the service station has a capability to provide a service corresponding to the service identifier, and the service identifier is obtained by the access point from service requirement information transmitted by a station to be served;
returning, by the service station, service request success information to the access point after the service station determines, based on the service request information, that the service station has the capability to provide the service corresponding to the service identifier; and
receiving, by the service station, association request information transmitted to the service station by the access point based on the service request success information, where the association request information is configured to be used by the service station to associate the service station with the access point.

In a third aspect of the present invention, a method for requesting an association is provided, which includes:
receiving, by a service station, association request information carrying a service identifier transmitted by an access point, where the service identifier is obtained by the access point from service requirement information transmitted by a station to be served; and
associating, by the service station, the service station with the access point based on the association request information, after the service station determines, based on the service identifier, that the service station has a capability to provide a service corresponding to the service identifier.

In a fourth aspect of the present invention, a method for requesting an association is provided, which includes:
receiving, by a service station, service request information transmitted by an access point, where the service request information carries a service identifier and the service request information is configured to be used by the service station to determine whether the service station has a capability to provide a service corresponding to the service identifier, and the service identifier is obtained by the access point from service requirement information transmitted by a station to be served; and
transmitting, by the service station, association request information to the access point after the service station determines, based on the service request information, that the service station has the capability to provide the service corresponding to the service identifier, where the association request information is configured to be used by the service station to associate the service station with the access point.

In a fifth aspect of the present invention, an access point is provided, which includes:
a receiving unit configured to receive service requirement information, where the service requirement information carries a service identifier and the service identifier is identification information of a service required by a station to be served;
a selecting unit configured to select a target service station capable of providing a service corresponding to the service identifier; and
an associating unit configured to associate the access point with the target service station.

In conjunction with the access point in the fifth aspect, in a first possible implementation, the associating unit is further configured to:
transmit service request information to the target service station, where the service request information carries the service identifier and the service request information is configured to be used by the target service station to determine whether the target service station has a capability to provide the service corresponding to the service identifier; receive service request success information transmitted by the target service station, where the service request success information is generated by the target service station after the target service station determines, based on the service request information, that the target service station has the capability to provide the service corresponding to the service identifier; and transmit association request information to the target service station based on the service request success information, where the association request information is configured to be used by the target service station to associate the target service station with the access point.

In conjunction with the access point in the fifth aspect, in a second possible implementation, the associating unit is further configured to:
transmit association request information carrying the service identifier to the target service station, where the association request information is configured to be used by the target service station to associate the target service station with the access point after the target service station determines that the target service station has a capability to provide the service corresponding to the service identifier.

In conjunction with the access point in the fifth aspect, in a third possible implementation, the associating unit is further configured to:
transmit service request information to the target service station, where the service request information carries the service identifier and the service request information is configured to be used by the target service station to determine whether the target service station has a capability to provide the service corresponding to the service identifier; and associate access point with the target service station in a case where association request information transmitted by the target service station is received within a preset period of time, where the association request information is transmitted to the access point by the target service station after the target service station determines, based on the service request information, that the target service station has the capability to provide the service corresponding to the service identifier.

In conjunction with the third possible implementation of the fifth aspect, in a fourth possible implementation, the associating unit is further configured to:
retransmit the service request information to the target service station, in a case where the association request information transmitted by the target service station is not received within the preset period of time.

In conjunction with the fifth aspect or the first to fourth possible implementations, in a fifth possible implementation, the selecting unit is further configured to:
select a service station which is capable of providing the service corresponding to the service identifier and is in an effective period of time for operation, as the target service station.

In a sixth aspect of the present invention, a service station is provided, which includes:
a receiving unit configured to receive service request information transmitted by an access point, where the service request information carries a service identifier and the service request information is configured to be used by the service station to determine whether the service station has a capability to provide a service corresponding to the service identifier, and the service identifier is obtained by the access point from service requirement information transmitted by a station to be served;
a transmitting unit configured to return service request success information to the access point after it is determined based on the service request information that there is the capability to provide the service corresponding to the service identifier; and
an associating unit configured to receive association request information transmitted to the service station by the access point based on the service request success information, where the association request information is configured to be used by the service station to associate the service station with the access point.

In a seventh aspect of the present invention, a service station is provided, which includes:
a receiving unit configured to receive association request information carrying a service identifier transmitted by an access point, where the service identifier is obtained by the access point from service requirement information transmitted by a station to be served; and an associating unit configured to associate the service station with the access point based on the association request information, after it is determined based on the service identifier that the service station has a capability to provide a service corresponding to the service identifier.

In an eighth aspect of the present invention, a service station is provided, which includes:
a receiving unit configured to receive service request information transmitted by an access point, where the service request information carries a service identifier and the service request information is configured to be used by the service station to determine whether the service station has a capability to provide a service corresponding to the service identifier, and the service identifier is obtained by the access point from service requirement information transmitted by a station to be served; and
an associating unit configured to transmit association request information to the access point after it is determined based on the service request information that there is the capability to provide the service corresponding to the service identifier, where the association request information is configured to be used by the service station to associate the service station with the access point.

In a ninth aspect of the present invention, a communication system is provided, which includes the station to be served, the access point and the service station as described above, and the station to be served, the access point and the service station are communicatively connected.

With the method for requesting the association, the apparatus and the system according the present invention, the access point receives the service requirement information, selects a target service station capable of providing the service corresponding to the service identifier based on the service identifier carried in the service requirement information, and then associates itself with the target service station. In this case, the access point can actively request to establish an association relationship with the service station, thereby improving a utilization rate and flexibility of the service station.

### BRIEF DESCRIPTION OF THE DRAWINGS

FIG. 1 is a flowchart of a method for requesting an association according to an embodiment of the present invention;

FIG. 2 is a flowchart of another method for requesting an association according to an embodiment of the present invention;

FIG. 3 is a flowchart of another method for requesting an association according to an embodiment of the present invention;

FIG. 4 is a flowchart of another method for requesting an association according to an embodiment of the present invention;

FIG. 5a is a schematic structural diagram of an access point according to an embodiment of the present invention;

FIG. 5b is a schematic structural diagram of another access point according to an embodiment of the present invention;

FIG. 6a is a schematic structural diagram of a service station according to an embodiment of the present invention;

FIG. 6b is a schematic structural diagram of another service station according to an embodiment of the present invention;

FIG. 7a is a schematic structural diagram of another service station according to an embodiment of the present invention;

FIG. 7b is a schematic structural diagram of another service station according to an embodiment of the present invention;

FIG. 8a is a schematic structural diagram of another service station according to an embodiment of the present invention;

FIG. 8b is a schematic structural diagram of another service station according to an embodiment of the present invention; and

FIG. 9 is a schematic structural diagram of a communication system according to an embodiment of the present invention.

### DETAILED DESCRIPTION OF THE EMBODIMENTS

A method in which an access point initiates a request for association with a service station is provided according to embodiments of the present invention, to address a problem of a reduced utilization rate of network resource due to occupied network resource for maintaining an association authentication relationship between a service station and an access point.

Since an access point can actively initiate to establish an association authentication relationship with a service station providing a service even if there is no association authentication relationship between the service station and the access point currently, the service station needs not to always maintain the association authentication relationship with the access point. The service station may end the association authentication relationship with the access point after providing the service and accordingly release network resource for the association authentication relationship, and thereby improving a utilization rate of network resource.

The embodiments of the present invention may be applied in an application scenario in which a certain service is used between two devices via an intermediary device. In the embodiments of the present invention, the station is a station to be served and the service station is a station capable of providing a service. The service station provides a service to the station via an access point. The service station may be a functional device such as a printer or a projector.

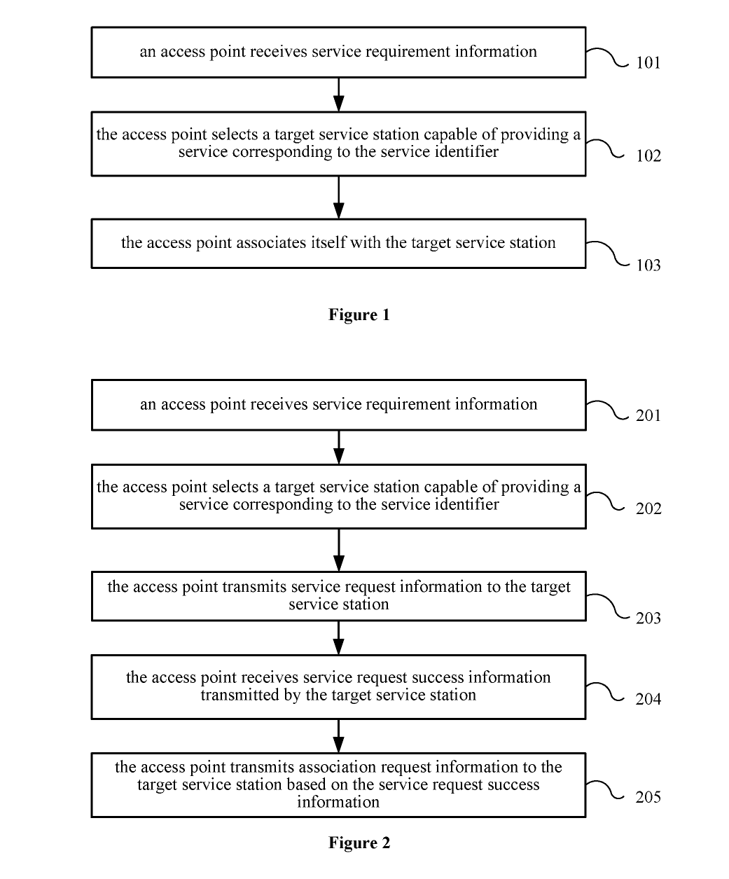

FIG. 1 is a flowchart of a method for requesting an association according to an embodiment of the present invention. As shown in FIG. 1, the method includes steps 101 to 103.

In step 101, an access point receives service requirement information. The service requirement information carries a service identifier. The service identifier is identification information of a service required by a station to be served.

A station may transmit service requirement information to the access point if the station requires a certain service. A service identifier of the service required by the station is carried in the service requirement information. The access point can learn which service is required by the station based on the service identifier.

The access point may learn, by performing information interaction with the service stations communicatively connected to the access point, services that the service stations can provide. Alternatively, the service station broadcasts the service that the service station can provide to the access point to which the service station can be communicatively connected. Therefore, the access point can learn the services that the service stations can provide and the services are stored in the access point in a form of a correspondence between identifiers of service stations and service identifiers. The access point can learn, from the correspondence, which service or services can be provided indirectly by the access point and which service station or service stations can provide these services.

The station may learn services that the access point can indirectly provide, by performing information interaction with the access point. Alternatively, the access point broadcasts the services that the access point can indirectly provide to stations within the coverage of the access point. Therefore, the service identifier carried in the service requirement information transmitted from the station to the access point is identification information of a service that the access point can provide.

Since a station can be communicatively connected to multiple access points, the station may firstly determine which access point or access points can provide the service required by the station according to the above method, and then transmit service requirement information to the access point which can provide the service.

In actual application, the service identifier may be carried in service requirement information, an authentication request, an association request or other information interacted with the access point, by the station.

In step 102, the access point selects a target service station capable of providing a service corresponding to the service identifier.

The access point searches the stored correspondence between the service identifiers and identifiers of the service stations based on the service identifier in the service requirement information.

If the access point finds one or more service stations corresponding to the service identifier in the correspondence, the one or more service stations may be determined as a target service station.

It should be noted that, the number of the target service station may be one or more. Each target service station is one of the service stations. The denomination of the “target service station” is for definitely indicating the object communicating with the access point.

It is a preferable case where the station learns the service that the access point can indirectly provide in advance. The access point may not find the target service station corresponding to the service identifier if the station does not learn the service that the access point can indirectly provide in advance.

In this case, the access point can not find the target service station, and the access point may communicatively interact with the station, to cause the station to learn that the access point can not indirectly provide this service for the station.

In step 103, the access point associates itself with the target service station.

The access point may request association with the target service station based on three flows as follows. The method for requesting association may adopt an implementation manner similar to that in the conventional technologies.

In the first flow, the access point transmits service request information to the target service station. The service request information carries a service identifier obtained from the service requirement information. The target service station determines whether the target service station has a capability to provide a service corresponding to the service identifier based on the service identifier. The target service station returns service request success information to the access point if the target service station has the capability to provide the service corresponding to the service identifier. The target service station returns service request failure information to the access point if the target service station does not have the capability to provide the service corresponding to the service identifier. If the access point receives the service request success information, the access point transmits association request information to the target service station, and performs an association between the access point and the target service station by communicatively interacting with the target service station. If the access point receives the service request failure information, the access point does not initiate the subsequent association.

In the second flow, the access point transmits association request information to the target service station. The association request information carries a service identifier obtained from the service requirement information. After receiving the association request information, the target service station determines whether the target service station has a capability to provide a service corresponding to the service identifier based on the service identifier in the association request information. If the target service station has the capability to provide the service corresponding to the service identifier, the target service station performs an association between the target service station and the access point by communicatively interacting with the access point. If the target service station does not have the capability to provide the service corresponding to the service identifier, the target service station feeds back information indicating a failure to the access point.

In the third flow, the access point transmits service request information to the target service station. The service request information carries a service identifier obtained from the service requirement information. The target service station determines whether the target service station has a capability to provide a service corresponding to the service identifier based on the service identifier. If the target service station has the capability to provide the service corresponding to the service identifier, the target service station returns service request success information to the access point. If the target service station does not have the capability to provide the service corresponding to the service identifier, the target service station returns service request failure information to the access point. In a case where the service request success information is returned to the access point by the target service station, the target service station continues to transmit association request information to the access point and performs an association between the target service station and the access point by interacting communicatively with the access point. In a case where the service request failure information is returned to the access point by the target service station, the target service station does not initiate the subsequent association.

With any one of the above three methods, an association relationship can be established between the access point and the target service station. In addition, the association relationship between the access point and the target service station is stored on both the access point and the target service station during the maintenance period of the association relationship.

With the method for requesting the association according to the embodiment of the present invention, the access point receives the service requirement information, selects the target service station capable of providing the service corresponding to the service identifier based on the service identifier carried in the service requirement information, and then associates itself with the target service station. Since the access point can actively request to establish an association relationship with a service station, the service station needs not to always maintain the association relationship with the access point. The service station may end the association relationship with the access point after providing the service and accordingly release network resource for the association relationship, and thereby improving a utilization rate of network resource. In addition, since the service station has an association relationship with only one access point at a time, the service station can establish or end an association relationship with different access point according to service requirements of the access point and the station by using the method according to the embodiment of the present invention, and thereby improving a utilization rate and flexibility of the service station.

FIG. 2 is a flowchart of another method for requesting an association according to an embodiment of the present invention. As shown in FIG. 2, the method includes steps 201 to 205.

In step 201, an access point receives service requirement information.

The implementation in step 101 may be referred to.

In step 202, the access point selects a target service station capable of providing a service corresponding to the service identifier.

The implementation in step 102 may be referred to.

Further, the access point selects a service station which is capable of providing the service corresponding to the service identifier and is in an effective period of time for operation, as the target service station.

Effective period of time for operation of each service station, i.e., a period of time during which the service station can operate normally, may also be stored in the access point, in addition to the correspondence between service identifiers and identifiers of the service stations.

After finding one or more service stations capable of providing the service corresponding to the service identifier, the access point further determines whether the current time is in the effective periods of time for operation of these service stations.

If the access point finds a service station which is capable of providing the service corresponding to the service identifier and is in the effective period of time for operation, the access point determines the service station as the target service station.

If the access point finds no service station which is capable of providing the service corresponding to the service identifier and is in the effective period of time for operation but finds service stations capable of providing the service corresponding to the service identifier, the stations capable of providing the service is determined as the target service station. Alternatively, the service station capable of providing the service but not in the effective period of time for operation currently is determined as the target service station until the service station enters the effective period of time for operation.

The access point can not determine a target service station if the access point finds no service station capable of providing the service corresponding to the service identifier.

In step 203, the access point transmits service request information to the target service station.

The service request information carries the service identifier, and the target service station determines whether the target service station has a capability to provide a service corresponding to the service identifier based on the service request information.

In a case where the number of the target service stations is more than one, the access point may transmit the service request information to the target service stations in the following way.

In the first way, after transmitting the service request information to one target service station, the access point waits to receive a reply from the target service station. The access point may continue to transmit the service request information to other target service stations if the access point receives the reply from the target service station. The access point may continue to transmit the service request information to other target service stations if the access point still does not receive the reply from the target service station after waiting for a certain period of time.

In the second way, after transmitting the service request information to one target service station, the access point may continue to transmit the service request information to other target service stations without waiting for a reply from the target service station.

In the third way, the access point may transmit the service request information to the target service stations in a multicasting way.

Alternatively, in the above three ways, the access point may stop transmitting the service request information to other target service stations after receiving the reply from one target service station.

Alternatively, the access point may transmit the service request information to all of the target service stations, and select, based on a certain screening condition, one service station from one or more target service station from which a reply is received by the access point within a certain period of time, as a final target service station.

In addition, the screening condition may be a service requirement put forward by a station to be served, such as a service type, a service time and a service price. Alternatively, the screening condition may be a communication condition between the target service station and the access point, such as a channel condition, a busy degree, a communication quality and a supported rate, which can be obtained from interaction between the access point and the target service station.

In step 204, the access point receives service request success information transmitted by the target service station.

The service request success information is generated by the target service station after the target service station determines, based on the service request information, that the target service station has the capability to provide the service corresponding to the service identifier.

After receiving the service request information transmitted by the access point, the target service station determines, based on the service identifier in the service request information, whether the target service station has the capability to provide the service corresponding to the service identifier.

Determining whether the target service station has the capability to provide the service includes contents as follows: whether the target service station has the service; whether the target service station has no association authentication relationship with other access points currently; whether the target service station is currently in a normal operation state; and the like.

It may be set as needed which determination criteria are used to determine whether the target service station has the capability to provide the service.

In a case where the target service station determines that the target service station has the capability to provide the service corresponding to the service identifier, the target service station returns service request success information to the access point. In a case where the target service station determines that the target service station does not have the capability to provide the service corresponding to the service identifier, the target service station returns service request failure information to the access point.

In step 205, the access point transmits association request information to the target service station based on the service request success information. The target service station associates itself with the access point based on the association request information.

If the service request success information returned from the target service station is received by the access point, the access point transmits the association request information to the target service station.

The association request information is used for association between the target service station and the access point. The method for associating the target service station with the access point may adopt an implementation manner similar to that in the conventional technologies.

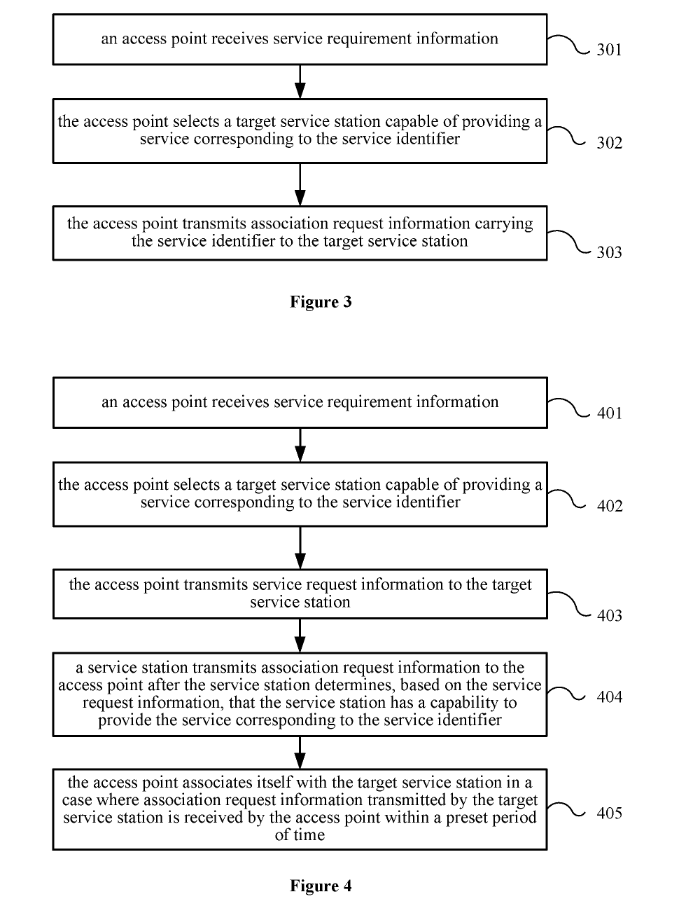

FIG. 3 is a flowchart of another method for requesting an association according to an embodiment of the present invention. As shown in FIG. 3, the method may include steps 301 to 303.

In step 301, an access point receives service requirement information.

The implementation in step 101 may be referred to.

In step 302, the access point selects a target service station capable of providing a service corresponding to the service identifier.

The implementation in step 102 or 202 may be referred to.

In step 303, the access point transmits association request information carrying the service identifier to the target service station. The target service station associates itself with the access point based on the association request information, after the target service station determines that the target service station has a capability to provide the service corresponding to the service identifier.

The access point may transmit the association request information to the target service station directly, with the association request information carrying the service identifier.

After receiving the association request information, the target service station may determine whether the target service station has the capability to provide the service based on the service identifier in the association request information. The implementation for determining whether the target service station has a service capability may refer to related contents described in step 204.

In a case where the number of the target service stations is more than one, the implementation for transmitting the association request information by the access point may refer to the implementation for transmitting the service request information in step 203.

The target service station may associate itself with the access point by interacting communicatively with the access point in a case where the target service station determines that the target service station has the capability to provide the service. The target service station does not associate itself with the access point in a case where the target service station determines that the target service station does not have the capability to provide the service.

The association request information is used for association between the target service station and the access point. The method for associating the target service station with the access point may adopt an implementation similar to that in the conventional technologies.

FIG. 4 is a flowchart of another method for requesting an association according to an embodiment of the present invention. As shown in FIG. 4, the method includes steps 401 to 405.

In step 401, an access point receives service requirement information.

The implementation in step 101 may be referred to.

In step 402, the access point selects a target service station capable of providing a service corresponding to the service identifier.

The implementation in step 102 or 202 may be referred to.

In step 403, the access point transmits service request information to the target service station.

The service request information carries the service identifier, and the target service station determines whether the target service station has a capability to provide a service corresponding to the service identifier based on the service request information.

The implementation in step 203 may be referred to.

In step 404, after a service station determines, based on the service request information, that the service station has the capability to provide the service corresponding to the service identifier, the service station transmits association request information to the access point. The association request information is used for the association with the service station.

After receiving the service request information transmitted by the access point, the target service station determines, based on the service identifier in the service request information, whether the target service station has the capability to provide the service corresponding to the service identifier.

Determining whether the target service station has the capability to provide the service includes contents as follows: whether the target service station has the service; whether the target service station has no association authentication relationship with other access points currently; whether the target service station is currently in a normal operation state, and the like.

It may be set as needed which determination criteria are used to determine whether the target service station has the capability to provide the service.

In a case where the target service station determines that the target service station has the capability to provide the service corresponding to the service identifier, the target service station returns service request success information to the access point and transmits association request information to the access point. In a case where the target service station determines that the target service station does not have the capability to provide the service corresponding to the service identifier, the target service station returns service request failure information to the access point and does not transmit association request information to the access point.

In step 405, the access point associates itself with the target service station in a case where association request information transmitted by the target service station is received by the access point within a preset period of time.

A time duration is preset in the access point, which indicates a maximum duration, during which the access point waits for receiving the association request information, after the service request information is transmitted to the target service station by the access point. The access point determines whether the association request information transmitted by the target service station is received within the preset period of time.

In a case where the association request information is received by the access point within the preset period of time, the access point performs an association between the access point and the target service station by interacting communicatively with the target service station.

The association request information is used for the association between the target service station and the access point. The method for associating the target service station with the access point may adopt an implementation similar to that in the conventional technologies.

In a case where the association request information transmitted by the target service station is not received by the access point within the preset period of time, the access point may retransmit the service request information to the target service station. Alternatively, the access point may not retransmit the service request information or transmit the service request information to other target service stations.

FIG. 5a is a schematic structural diagram of an access point according to an embodiment of the present invention. As shown in FIG. 5a, the access point includes a receiving unit 11, a selecting unit 12 and an associating unit 13.

The receiving unit 11 is configured to receive service requirement information, where the service requirement information carries a service identifier, and the service identifier is identification information of a service required by a station to be served.

The selecting unit 12 is configured to select a target service station capable of providing a service corresponding to the service identifier.

The associating unit 13 is configured to associate the access point with the target service station.

Furthermore, the associating unit 13 is further configured to:

transmit service request information to the target service station, where the service request information carries the service identifier and the service request information is configured to be used by the target service station to determine whether the target service station has a capability to provide the service corresponding to the service identifier; receive service request success information transmitted by the target service station, where the service request success information is generated by the target service station after the target service station determines, based on the service request information, that the target service station has the capability to provide the service corresponding to the service identifier; and transmit association request information to the target service station based on the service request success information, where the association request information is configured to be used by the target service station to associate the target service station with the access point.

Furthermore, the associating unit 13 is further configured to:
transmit association request information carrying the service identifier to the target service station, where the association request information is configured to be used by the target service station to associate the target service station with the access point after the target service station determines that the target service station has a capability to provide the service corresponding to the service identifier.

Furthermore, the associating unit 13 is further configured to:
transmit service request information to the target service station, where the service request information carries the service identifier and the service request information is configured to be used by the target service station to determine whether the target service station has a capability to provide the service corresponding to the service identifier; and associate the access point with the target service station if association request information transmitted by the target service station is received within a preset period of time, where the association request information is transmitted to the access point by the target service station after the target service station determines, based on the service request information, that the target service station has the capability to provide the service corresponding to the service identifier.

Furthermore, the associating unit 13 is further configured to:
retransmit the service request information to the target service station, if the association request information transmitted by the target service station is not received within the preset period of time.

Furthermore, the selecting unit 12 is further configured to:
select a service station which is capable of providing the service corresponding to service identifier and is in an effective period of time for operation, as the target service station.

FIG. 5b is a schematic structural diagram of another access point according to an embodiment of the present invention. As shown in FIG. 5b, the access point includes a processor 21, a memory 22, a bus 23 and a communication interface 24. The processor 21, the memory 22 and the communication interface 24 are connected via the bus 23 and communicate with each other via the bus 23.

The processor 21 may be a single-core or multi-core central processing unit (CPU), or an application specific integrated circuit (ASIC), or may be embodied as one or more integrated circuits implementing the embodiment of the present invention.

The memory 22 may be a high speed RAM memory or a non-volatile memory such as at least one magnetic disk memory.

The memory 22 is configured to store a program 221. The program 221 may include program codes including computer operation instructions.

The communication interface 24 is configured to receive service requirement information, where the service requirement information carries a service identifier, and the service identifier is identification information of a service required by a station to be served.

The processor 21 runs the program 221 to:

select a target service station capable of providing a service corresponding to the service identifier and associate the access point with the target service station.

The method for requesting an association by the access point according to the embodiment of the present invention may refer to the operation steps described in the corresponding method embodiments above.

The access point according to the embodiment of the present invention receives the service requirement information, selects the target service station capable of providing the service corresponding to the service identifier based on the service identifier carried in the service requirement information, and then associates itself with the target service station. Since the access point can actively request to establish an association authentication relationship with a service station, the service station needs not to always maintain the association authentication relationship with the access point. The service station may end the association authentication relationship with the access point after providing the service, and accordingly release network resource for the association authentication relationship, and thereby improving a utilization rate of network resource. In addition, since the service station has an association authentication relationship with only one access point at a time, the service station can establish or end an association authentication relationship with different access point according to service requirements of the access point and the station by using the method according to the embodiment of the present invention, and thereby improving a utilization rate and flexibility of the service station.

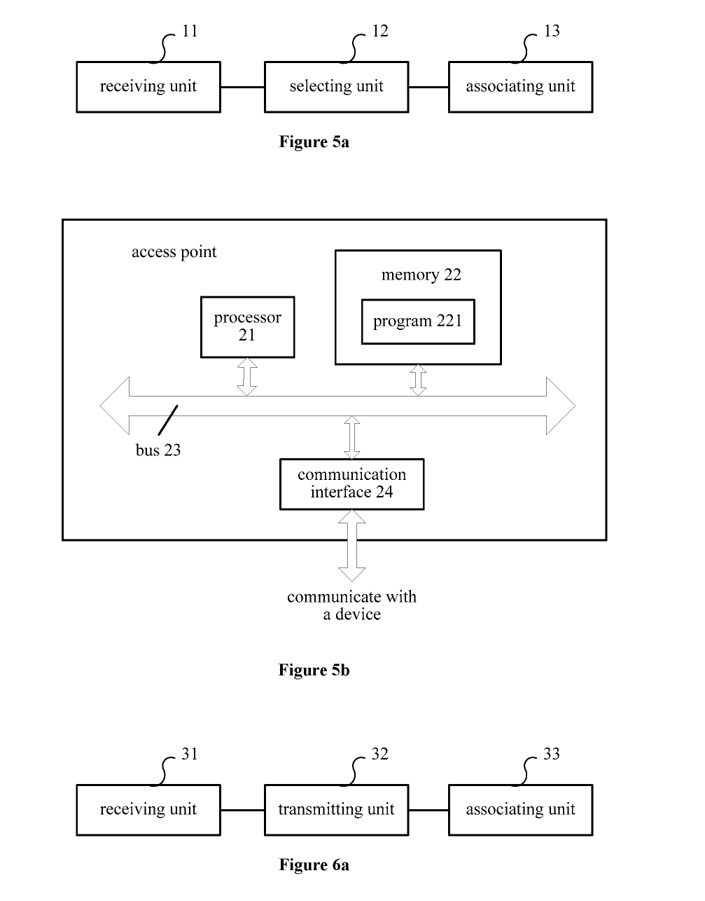

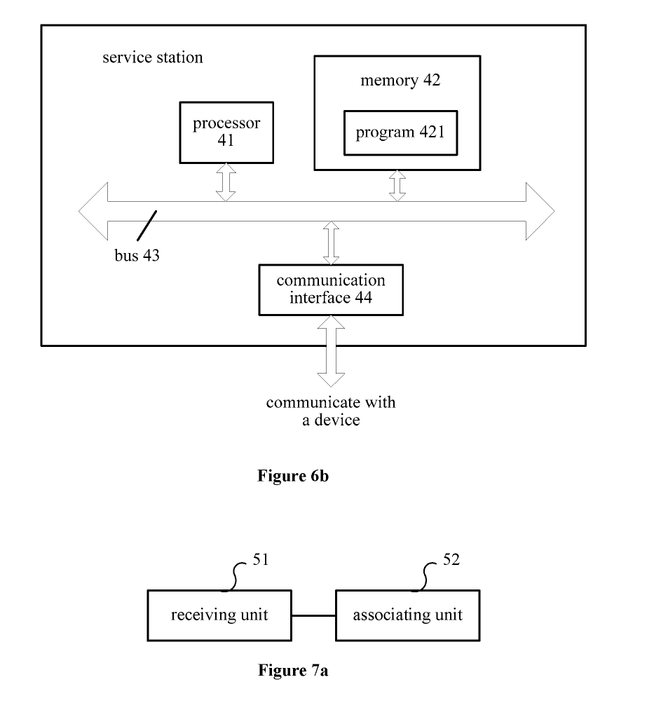

FIG. 6a is a schematic structural diagram of a service station according to an embodiment of the present invention. As shown in FIG. 6a, the service station includes a receiving unit 31, a transmitting unit 32 and an associating unit 33.

The receiving unit 31 is configured to receive service request information transmitted by an access point, where the service request information carries a service identifier and the service request information is configured to be used by the service station to determine whether the service station has a capability to provide a service corresponding to the service identifier, and the service identifier is obtained by the access point from service requirement information transmitted by a station to be served.

The transmitting unit 32 is configured to return service request success information to the access point after it is determined based on the service request information that there is the capability to provide the service corresponding to the service identifier.

The associating unit 33 is configured to receive association request information transmitted to the service station by the access point based on the service request success information, where the association request information is configured for association with the service station.

FIG. 6b is a schematic structural diagram of another service station according to an embodiment of the present invention. As shown in FIG. 6b, the service station includes a processor 41, a memory 42, a bus 43 and a communication interface 44. The processor 41, the memory 42 and the communication interface 44 are connected via the bus 43 and communicate with each other via the bus 43.

The processor 41 may be a single-core or multi-core central processing unit (CPU), or an application specific integrated circuit (ASIC), or may be embodied as one or more integrated circuits implementing the embodiment of the present invention.

The memory 42 may be a high speed RAM memory or a non-volatile memory such as at least one magnetic disk memory.

The memory 42 is configured to store a program 421. The program 421 may include program codes including computer operation instructions.

The communication interface 44 is configured to receive service request information transmitted by the access point. The service request information carries a service identifier. The service request information is configured to be used by the service station to determine whether the service station has a capability to provide a service corresponding to the service identifier. The service identifier is obtained by the access point from service requirement information transmitted by a station to be served.

The processor 41 runs the program 421 to:

return service request success information to the access point after it is determined based on the service request information that there is the capability to provide the service corresponding to the service identifier; and receive association request information transmitted to the service station by the access point based on the service request success information, where the association request information is configured to be used by the service station to associate the service station with the access point.

The method for accepting a request for an association by the service station according to the embodiment of the present invention may refer to the operation steps described in the corresponding method embodiments above.

The service station according to the embodiment of the present invention receives the service request information transmitted by the access point, returns service request success information to the access point after the service station determines, based on the service request information, that the service station has the capability to provide the service corresponding to the service identifier, and receives association request information transmitted to the service station by the access point based on the service request success information, where the association request information is configured to be used by the service station to associate itself with the access point. Since the access point can actively request to establish an association authentication relationship with a service station, the service station needs not to always maintain the association authentication relationship with the access point. The service station may end the association authentication relationship with the access point after providing the service, and accordingly release network resource for the association authentication relationship, and thereby improving a utilization rate of network resource. In addition, since the service station has an association authentication relationship with only one access point at a time, the service station can establish or end an association authentication relationship with different access point according to service requirements of the access point and the station by using the method according to the embodiment of the present invention, and thereby improving a utilization rate and flexibility of the service station.

FIG. 7a is a schematic structural diagram of another service station according to an embodiment of the present invention. As shown in FIG. 7a, the service station includes a receiving unit 51 and an associating unit 52.

The receiving unit 51 is configured to receive association request information carrying a service identifier transmitted by an access point, where the service identifier is obtained by the access point from service requirement information transmitted by a station to be served.

The associating unit 52 is configured to associate the service station with the access point based on the association request information, after it is determined based on the service identifier that there is a capability to provide a service corresponding to the service identifier.

FIG. 7b is a schematic structural diagram of another service station according to an embodiment of the present invention. As shown in FIG. 7b, the service station includes a processor 61, a memory 62, a bus 63 and a communication interface 63. The processor 61, the memory 62 and the communication interface 64 are connected via the bus 63 and communicate with each other via the bus 63.

The processor 61 may be a single-core or multi-core central processing unit (CPU), or an application specific integrated circuit (ASIC), or may be embodied as one or more integrated circuits implementing the embodiment of the present invention.

The memory 62 may be a high speed RAM memory or a non-volatile memory such as at least one magnetic disk memory.

The memory 62 is configured to store a program 621. The program 421 may include program codes including computer operation instructions.

The communication interface 64 is configured to receive association request information carrying a service identifier transmitted by the access point, and the service identifier is obtained by the access point from service requirement information transmitted by a station to be served.

The processor 61 runs the program 621 to:
associate the service station with the access point based on the association request information, after it is determined based on the service identifier that there is a capability to provide a service corresponding to the service identifier.

The method for accepting a request for an association by the service station according to the embodiment of the present invention may refer to the operation steps described in the corresponding method embodiments above.

The service station according to the embodiment of the present invention receives the association request information carrying the service identifier transmitted by the access point, and associates it self with the access point based on the association request information after the service station determines, based on the service identifier, that the service station has the capability to provide the service corresponding to the service identifier. Since the access point can actively request to establish an association authentication relationship with a service station, the service station needs not to always maintain the association authentication relationship with the access point. The service station may end the association authentication relationship with the access point after providing the service, and accordingly release network resource for the association authentication relationship, and thereby improving a utilization rate of network resource. In addition, since the service station has an association authentication relationship with only one access point at a time, the service station can establish or end an association authentication relationship with different access point according to service requirements of the access point and the station by using the method according to the embodiment of the present invention, and thereby improving a utilization rate and flexibility of the service station.

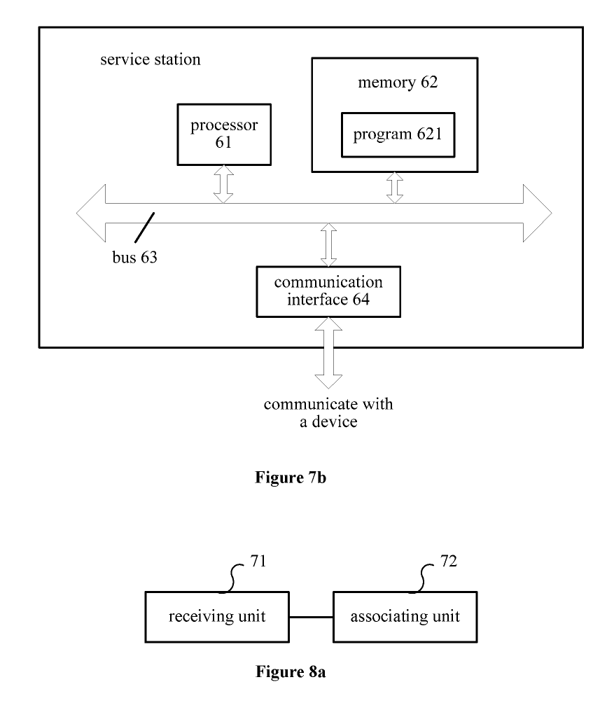

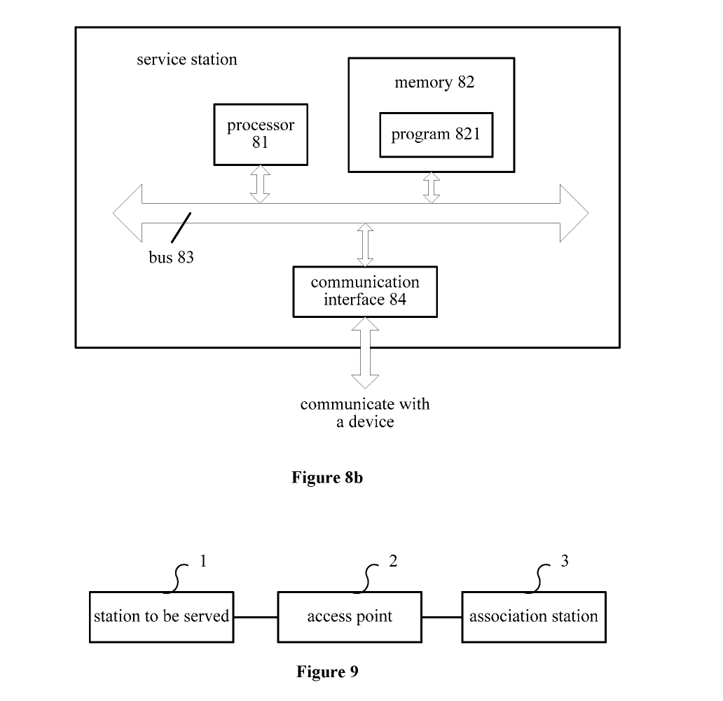

FIG. 8a is a schematic structural diagram of another service station according to an embodiment of the present invention. As shown in FIG. 8a, the service station includes: a receiving unit 71 and an associating unit 72.

The receiving unit 71 is configured to receive service request information transmitted by an access point, where the service request information carries a service identifier and the service request information is configured to be used by the service station to determine whether the service station has a capability to provide a service corresponding to the service identifier, and the service identifier is obtained by the access point from service requirement information transmitted by a station to be served.

The associating unit 72 is configured to transmit association request information to the access point after it is determined based on the service request information that there is the capability to provide the service corresponding to the service identifier, where the association request information is configured for association with the service station.

FIG. 8b is a schematic structural diagram of another service station according to an embodiment of the present invention. As shown in FIG. 8b, the service station includes a processor 81, a memory 82, a bus 83 and a communication interface 84. The processor 81, the memory 82 and the communication interface 84 are connected via the bus 83 and communicate with each other via the bus 83.

The processor 81 may be a single-core or multi-core central processing unit (CPU), or an application specific integrated circuit (ASIC), or may be embodied as one or more integrated circuits implementing the embodiment of the present invention.

The memory 82 may be a high speed RAM memory or a non-volatile memory such as at least one magnetic disk memory.

The memory 82 is configured to store a program 821. The program 821 may include program codes including computer operation instructions.

The communication interface 84 is configured to receive service request information transmitted by an access point. The service request information carries a service identifier. The service request information is configured to be used by the service station to determine whether the service station has a capability to provide a service corresponding to the service identifier, and the service identifier is obtained by the access point from service requirement information transmitted by a station to be served.

The processor 81 runs the program 821 to:
transmit association request information to the access point after it is determined based on the service request information that there is the capability to provide the service corresponding to the service identifier, where the association request information is configured to be used by the service station to associate itself with the access point.

The method for accepting a request for an association by the service station according to the embodiment of the present invention may refer to the operation steps described in the corresponding method embodiments above.

The service station according to the embodiment of the present invention receives the service request information transmitted by the access point, and transmits the association request information to the access point after the service station determines, based on the service request information, that the service station has the capability to provide the service corresponding to the service identifier, where the association request information is configured to be used by the service station to associate itself with the access point. Since the access point can actively request to establish an association authentication relationship with a service station, the service station needs not to always maintain the association authentication relationship with the access point. The service station may end the association authentication relationship with the access point after providing the service, and accordingly release network resource for the association authentication relationship, and thereby improving a utilization rate of network resource. In addition, since the service station has an association authentication relationship with only one access point at a time, the service station can establish or end an association authentication relationship with different access point according to service requirements of the access point and the station by using the method according to the embodiment of the present invention, and thereby improving a utilization rate and flexibility of the service station.

FIG. 9 is a schematic structural diagram of a communication system according to an embodiment of the present invention. As shown in FIG. 9, the communication system includes a station 1 to be served, the access point 2 as shown in FIG. 5a or 5b and a service station 3. The service station 3 may be the one as shown in FIG. 6a or 6b, or as shown in FIG. 7a or 7b, or as shown in FIG. 8a or 8b. The station 1 to be served, the access point 2 and the service station 3 are communicatively connected.

The method for requesting an association, which is implemented in the communication system according to the embodiment of the present invention, may refer to the operation steps described in the corresponding method embodiments above.

It is to be understood by those skilled in the art that, all of or a few of the steps of the method embodiments may be implemented with hardware related to program instructions. The foregoing program may be stored in a computer readable storage medium. The program, when being executed, performs the steps of the above method embodiments. The foregoing storage medium includes various mediums that can store program codes, such as a ROM, a RAM, a magnetic disk or an optical disk.

Finally, it should be noted that, the above embodiments are only used to describe the technical solutions of the preset invention and are not intended to limit the invention. Although the present invention is illustrated in detail with reference to the embodiments above, those skilled in the art should appreciate that the technical solutions described in the above embodiments may be changed or a part or all of the technical features may be substituted equivalently, with these changes or substitutions not cause the essence of the corresponding technical solutions to depart from the scope of the technical solutions of the embodiments of the present invention.

What is claimed is:

1. A method for requesting an association, comprising:
receiving, by an access point, service requirement information, wherein the service requirement information carries a service identifier and the service identifier is identification information of a service required by a station to be served;
selecting, by the access point, a target service station capable of providing a service corresponding to the service identifier; and
associating, by the access point, the access point with the target service station.

2. The method for requesting the association according to claim 1, wherein associating, by the access point, the access point with the target service station comprises:
transmitting, by the access point, service request information to the target service station, wherein the service request information carries the service identifier, and the service request information is configured to be used by the target service station to determine whether the target service station has a capability to provide the service corresponding to the service identifier;
receiving, by the access point, service request success information transmitted by the target service station, wherein the service request success information is generated by the target service station after the target service station determines, based on the service request information, that the target service station has the capability to provide the service corresponding to the service identifier; and
transmitting, by the access point, association request information to the target service station based on the service request success information, wherein the association request information is configured to be used by the target service station to associate the target service station with the access point.

3. The method for requesting the association according to claim 1, wherein associating, by the access point, the access point with the target service station comprises:
transmitting, by the access point, association request information carrying the service identifier to the target service station, wherein the association request information is configured to be used by the target service station to associate the target service station with the access point after the target service station determines that the target service station has a capability to provide the service corresponding to the service identifier.

4. The method for requesting the association according to claim 1, wherein associating, by the access point, the access point with the target service station comprises:
transmitting, by the access point, service request information to the target service station, wherein the service request information carries the service identifier, and service request information is configured to be used by the target service station to determine whether the target service station has a capability to provide the service corresponding to the service identifier; and
associating, by the access point, the access point with the target service station in a case where association request information transmitted by the target service station is received by the access point within a preset period of time, wherein the association request information is transmitted to the access point by the target service station after the target service station determines, based on the service request information, that the target service station has the capability to provide the service corresponding to the service identifier.

5. The method for requesting the association according to claim 4, further comprising:
retransmitting, by the access point, the service request information to the target service station, in a case where the association request information transmitted by the target service station is not received by the access point within the preset period of time.

6. The method for requesting the association according to claim 1, wherein selecting, by the access point, the target service station capable of providing the service corresponding to the service identifier comprises:
selecting, by the access point, a service station which is capable of providing the service corresponding to the service identifier and is in an effective period of time for operation, as the target service station.

7. A method for requesting an association, comprising:
receiving, by a service station, service request information transmitted by an access point, wherein the service request information carries a service identifier and the service request information is configured to be used by the service station to determine whether the service station has a capability to provide a service corresponding to the service identifier, and the service identifier is obtained by the access point from service requirement information transmitted by a station to be served;
returning, by the service station, service request success information to the access point after the service station determines, based on the service request information, that the service station has the capability to provide the service corresponding to the service identifier; and
receiving, by the service station, association request information transmitted to the service station by the access point based on the service request success information, wherein the association request information is configured to be used by the service station to associate the service station with the access point.

8. An access point, comprising a processor and a non-transitory processor-readable medium having processor-executable instructions stored thereon that, when executed by the processor, cause the access point to:
receive service requirement information, wherein the service requirement information carries a service identifier, and the service identifier is identification information of a service required by a station to be served;
select a target service station capable of providing a service corresponding to the service identifier; and
associate the access point with the target service station.

9. The access point according to claim 8, wherein instructions causing the access point to associate the access point with the target service station further comprises instructions causing the access point to:
transmit service request information to the target service station, wherein the service request information carries the service identifier and the service request information is configured to be used by the target service station to determine whether the target service station has a capability to provide the service corresponding to the service identifier; receive service request success information transmitted by the target service station, wherein the service request success information is generated by the target service station after the target service station determines, based on the service request information, that the target service station has the capability to provide the service corresponding to the service identifier; and transmit association request information to the target service station based on the service request success information, wherein the association request information is configured to be used by the target service station to associate the target service station with the access point.

10. The access point according to claim 8, wherein instructions causing the access point to associate the access point with the target service station further comprises instructions causing the access point to:
transmit association request information carrying the service identifier to the target service station, wherein the association request information is configured to be used by the target service station to associate the target service station with the access point after the target service station determines that the target service station has a capability to provide the service corresponding to the service identifier.

11. The access point according to claim 8, wherein instructions causing the access point to associate the access point with the target service station further comprises instructions causing the access point to:
transmit service request information to the target service station, wherein the service request information carries the service identifier and the service request information is configured to be used by the target service station to determine whether the target service station has a capability to provide the service corresponding to the service identifier; and associate the access point with the target service station in a case where association request information transmitted by the target service station is received within a preset period of time, wherein the association request information is transmitted to the access point by the target service station after the target service station determines, based on the service request information, that the target service station has the capability to provide the service corresponding to the service identifier.

12. The access point according to claim 11, wherein instructions causing the access point to associate the access point with the target service station further comprises instructions causing the access point to:
retransmit the service request information to the target service station, in a case where the association request information transmitted by the target service station is not received within the preset period of time.

13. The access point according to claim 8, wherein instructions causing the access point to select a target service station capable of providing a service corresponding to the service identifier further comprises instructions causing the access point to:
select a service station which is capable of providing the service corresponding to the service identifier and is in an effective period of time for operation, as the target service station.

14. A service station, comprising a processor and a non-transitory processor-readable medium having processor-executable instructions stored thereon that, when executed by the processor, cause the access point to:
receive service request information transmitted by an access point, wherein the service request information carries a service identifier and the service request information is configured to be used by the service station to determine whether the service station has a capability to provide a service corresponding to the service identifier, and the service identifier is obtained by the access point from service requirement information transmitted by a station to be served;
return service request success information to the access point after it is determined based on the service request information that there is the capability to provide the service corresponding to the service identifier; and
receive association request information transmitted to the service station by the access point based on the service request success information, wherein the association request information is configured to be used by the service station to associate the service station with the access point.
